(19) United States
(12) Patent Application Publication
(10) Pub. No.: US 2003/0069896 A1
(43) Pub. Date: Apr. 10, 2003

(54) System, method and computer program product for accessing electronic game information for a plurality of hunters

(76) Inventors: John Byrne, Rock Hill, SC (US); James Lee Harrison, Charlotte, NC (US); Peter Smith, Chapel Hill, NC (US); David Stribling, Rock Hill, NC (US); David Svetcov, Conover, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/974,236

(22) Filed: Oct. 10, 2001

(51) Int. Cl. G06F 7/00

(52) U.S. Cl. 707/104.1

(57) ABSTRACT

A system for accessing electronic game information for a plurality of hunters includes a processing element, at least one electronic database and an output element. The processing element can receive game information that is associated with at least one hunting area and at least one hunting trip. The processing element can additionally determine weather information for at least one time during the hunting trips. The electronic databases, which are located remote from the processing element, can store the electronic game information, and the weather determined by the processing element. The output element, in turn, can output dynamic electronic information at least partially based upon the electronic game information and the hunters, and can output the weather information for the times during the hunting trips.

### FIELD OF THE INVENTION

The present invention relates to systems and methods of providing electronic game information and, more particularly, to systems and methods of providing electronic game information for a plurality of hunters.

### BACKGROUND OF THE INVENTION

The popularity of game hunting, including hunting for birds and fishes, whether hunted for food or taken for sport or profit, is ever increasing. As used herein, hunting shall include both hunting for animals on land and fishing on any body of water. As such, game shall include animals, birds, fish and the like, while a hunter shall include both individuals hunting for animals on land and anglers fishing the various bodies of water.

For example, according to many reports today, more people participate in recreational fishing in the United States than in golf and tennis combined. And even the best hunters often have difficulty finding and catching the game they are pursuing. In an attempt to improve their knowledge of where game might be, and to generally increase the quality and success of their hunting experience, more and more hunters are using state-of-the-art technology, such as global positioning satellites and sonar technology, to help them map out and view the contents of the areas they are hunting. In addition, feeding habits and seasonal movement patterns are being studied to better understand the game and their habits.

For example, with respect to fishing, to determine where fish will be and the likelihood of a fish striking at any given time, a multitude of variables must be analyzed. Among these variables, anglers must consider location, weather conditions, water temperature, time of year, techniques and equipment used. Because of the complexity of the interactions of the variables, however, considering the multitude of variables is generally far too complex for the human brain to accurately process and understand. In this regard, anglers could spend a lifetime in their local waters alone trying to determine how the interactions between these variables impact their ability to predict the best methods and timing for catching fish.

To assist anglers in analyzing many of the variables, anglers have long kept fishing journals that include the variables for each fishing trip the angler took. While these fishing journals assisted the angler somewhat in increasing the angler's chance of success, journals kept by individual anglers are inherently limiting in that such journals only contain entries for each angler. In this regard, anglers often have very limited information as to variations of the variables sufficient enough to formulate an adequate determination of the likelihood of a fish striking at any given time. In addition, as weather is a variable that tends to affect the habits of fish, adequately documenting a fishing trip in a journal requires anglers to document the weather during each fishing trip or while catching each fish. But due to the faulty memories of many anglers and inconsistencies in documenting weather, adequate documentation of weather is often difficult to keep. Therefore, it would be desirable to develop a system that integrates the journals of a plurality of hunters, including anglers, and provides a uniform method by which weather during a hunting trip can be determined and documented.

### SUMMARY OF THE INVENTION

In light of the foregoing background, the present invention provides systems, methods and computer program products for accessing electronic game information. The systems, methods and computer program products provide more comprehensive game information by containing information for a plurality of hunters, in addition to more conventional information associated with individual hunters. Thus, the present invention provides hunters with the information necessary to formulate an adequate determination of the likelihood of catching game, such as a fish striking, at any given time. In addition, the present invention is capable of determining and documenting the weather according to times of hunting trips of the hunters to thereby enhance the game information. In this regard, the weather is determined based on objective and consistent determinations, as opposed to the subjective determination of the anglers, which can vary.

According to one embodiment, a system for accessing electronic game information for a plurality of hunters includes a processing element, at least one electronic database and an output element, such as a graphical user interface (GUI). The processing element is capable of receiving game information that is associated with at least one hunting area, where at least a portion of the electronic game information is associated with at least one hunting trip. The processing element is additionally capable of determining weather information for at least one time during the at least one hunting trip.

The electronic databases, which are located remote from the processing element, are responsive to the processing element for storing electronic game information for the hunters based upon the fishing information received by the processing element, such as based upon the plurality of hunters and based upon the hunting areas. In a further embodiment, the processing element communicates with the electronic databases across a wide area network (WAN), such as the Internet. The electronic databases are capable of storing the weather information by the processing element along with the electronic game information.

The output element, which is also responsive to the processing element, is capable of outputting dynamic electronic information at least partially based upon the electronic game information and the hunters. The output element can further output the weather information for the times of the hunting trips. For example, the output element can output the dynamic electronic information based upon at least one of the hunters and the hunting areas. Also, for example, the output element can be responsive to a selection of at least a portion of the electronic game information to thereby display dynamic electronic information over a predetermined time period.

In a further embodiment, the system includes at least one electronic weather database capable of storing electronic weather information. In this embodiment, the processing element is capable of determining the weather information by communicating with the electronic weather databases. And in yet a further embodiment, the electronic weather information is stored in the electronic weather databases based upon a time and location. In this embodiment, the processing element is capable of determining the weather information according to the at least one time during the at least one hunting trip and further according to at least one place of the at least one hunting trip.

In operation, a method for accessing electronic fishing information for a plurality of hunters includes first receiving the game information. Then, the weather information for the times during the hunting trips is determined. Next, electronic game information for the plurality of hunters is stored based upon the game information received. In this regard, the weather information is stored along with the electronic game information. Next, the dynamic electronic information and the weather information for the times during the hunting trips are output, such as by selecting at least a portion of the game information before outputting the electronic game information and weather.

In another embodiment, the weather information is determined by communicating with at least one electronic weather database to thereby determine the weather information. For example, the weather information can be determined by communicating wit the electronic weather databases according to the at least one time during the at least one hunting trip and further according to at least one place of the at least one hunting trip. In one embodiment, the electronic game information is stored based upon the hunters and based upon the hunting areas. And in this embodiment, the electronic game information is displayed based upon at least one of the hunters and the hunting areas. For example, the electronic fishing information can be stored by communicating with at least one electronic database across a wide area network (WAN), such as the Internet.

The present invention therefore provides systems, methods and computer program products for accessing electronic game information. By including game information for a plurality of hunters, the present invention provides more comprehensive game information to thereby provide hunters with the information necessary to formulate an adequate determination of the likelihood of catching game at any given time. In addition, by determining and storing the weather associated with the hunting trips, the present invention can determine the weather based on objective and consistent determinations, as opposed to the subjective determination of the hunters, which can vary.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a system for accessing electronic game information, according to one embodiment of the present invention;

FIGS. 2A and 2B are schematic illustrative displays of a journal entry display of the graphical user interface of one embodiment of the present invention;

FIG. 3 is a schematic illustrative display of dynamic electronic information displayed by the graphical user interface of one embodiment of the present invention; and

FIG. 4 is another schematic illustrative display of dynamic electronic information displayed by the graphical user interface of one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

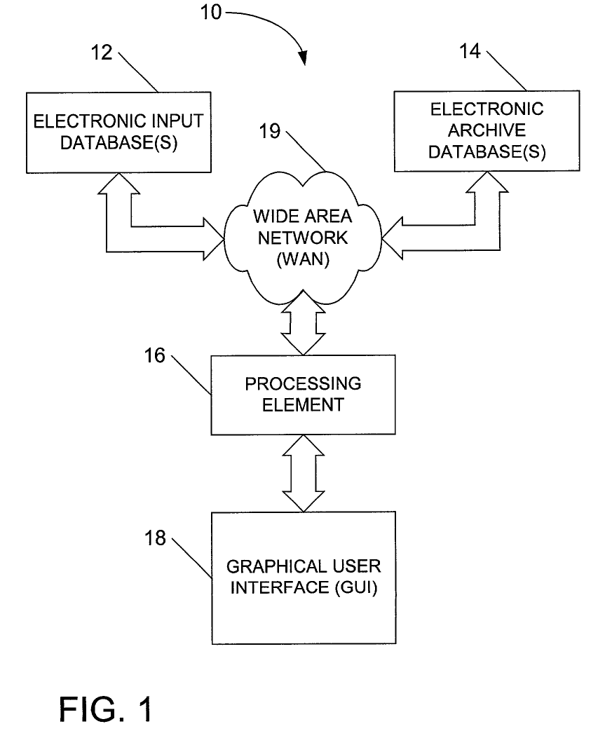

Referring to FIG. 1, a system 10 for providing game information for a plurality of hunters includes at least one electronic database 12, at least one electronic weather database 14, a processing element 16 and an output element, such as a graphical user interface (GUI) 18. The processing element is capable of receiving game information. The processing element can comprise any of a number of different devices, such as a personal computer or other high level processor. The electronic databases are capable of storing the game information. The electronic databases and the electronic weather databases, which is capable of storing electronic weather information, can comprise any of a number of known electronic databases. And whereas the electronic databases and electronic weather databases are illustrated and described as separate elements, it should be understood that the same electronic database can perform the functions of both the electronic databases and electronic weather databases without departing from the spirit and scope of the present invention. To communicate, the processing element and the electronic databases are in electrical communication. In this regard, the processing element and electronic databases can communicate in a number of different manners but, in a preferred embodiment, communicate via a wide area network (WAN) 19, such as the Internet. As a result, in one typical configuration, the processing element and GUI reside at a location proximate a hunter who inputs game information into the processing element. The processing element, in turn, can store the fishing information in the electronic databases, which can be connected to a central server and located remote from the processing element.

The game information received by the processing element 16 can originate from any of a number of different sources and can include any of a number of different pieces, of information. The game information can include information for any of a number of different game, including birds, fish and wildlife. In this regard, the hunters can include hunters of animals such as birds and fish, as well as anglers who hunt (i.e., fish) for fish. For example, fishing information can originate from historical records, such as those stored by states. Additionally, or alternatively, fishing information can originate from anglers who typically gather the fishing information during fishing trips. In this regard, since anglers preferably continue to take fishing trips and continue to gather fishing information, the contents of the electronic databases are constantly changing and being updated. As a result, in a preferred embodiment the hunting information is based on at least one hunting trip to at least one hunting area. A hunting trip can include a defined period of time a hunter hunts for a desired game, including fishing for a desired fish or species of fish. Also, a hunting area can include any of a number of locations defined by a boundary. For example, with respect to fishing, a fishing trip can be defined as a time period during a day an angler has fished for a desired species of fish. And the hunting area can be defined as a body of water, such as a lake, or a section of a body of water, such as the coastal area of an ocean or a portion of a river or other tributary.

With respect to fishing information, the fishing information for each trip can include trip information, as well as trip activity and catch information for each fish caught during the trip. The trip information can include information such as trip name, trip date, trip time, state trip taken to, lake fished, whether the trip was sponsored by a fishing club and the sponsoring club, whether the trip was a tournament, the number of fish strikes, the number of fish hook-ups and the number of fish caught (i.e., catches). The trip activity information can include information such as the number of fish strikes, fish hook-ups, fish caught and fish released. And the catch information can include information such as estimated catch time, fish species, bait and technique used to catch the fish, whether cover existed over the water at the catch location, location type of the body of water fished, lake section, water clarity, depth of the water of the fish when caught (i.e., catch depth), and length and weight of the fish caught.

In addition to receiving the game information, the processing element 16 can determine the weather at each point in time the hunter catches game based upon the estimated catch time and location of the catch. In this regard, the processing element can determine weather information such as temperature, wind speed, dew point, humidity, heat index, wind chill, barometer reading, sunrise and sunset times, and moon phase. Additionally, with respect to fishing information, the processing element can determine marine weather for different bodies of water, including information such as water temperature, water level and visibility. The processing element can store the weather data along with the electronic game information in the electronic databases.

The processing element can determine the weather utilizing any of a number of known systems, such as any of a number of known weather data systems. In one advantageous embodiment, the processing element determines the weather by communicating with an electronic weather database, which preferably stores the weather according to location and time. For example, one electronic weather database can include information from a weather service, such as Data Transmission Network, which provides the weather at fifteen minute intervals.

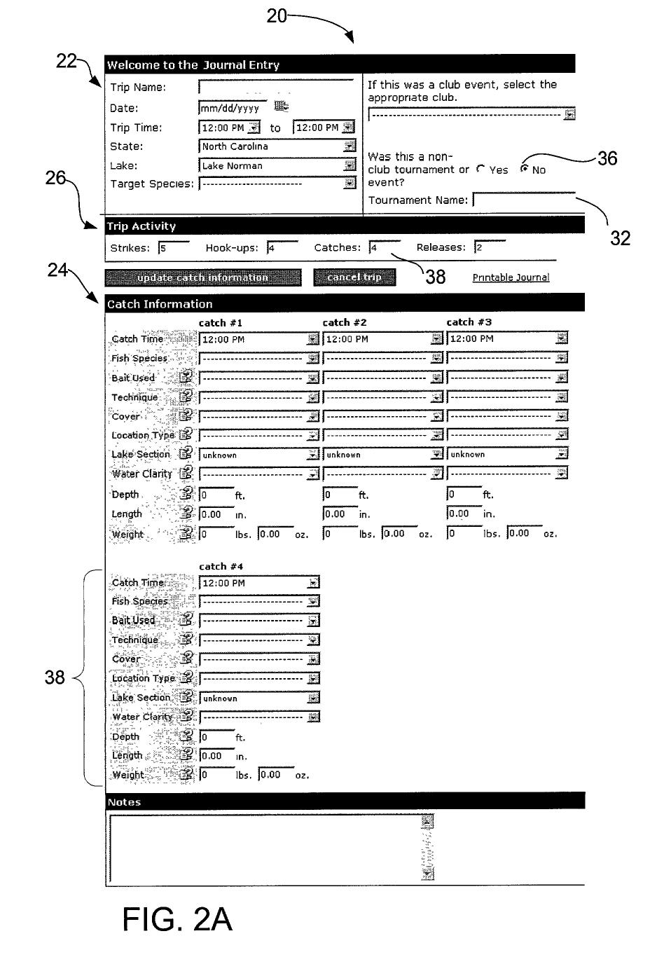

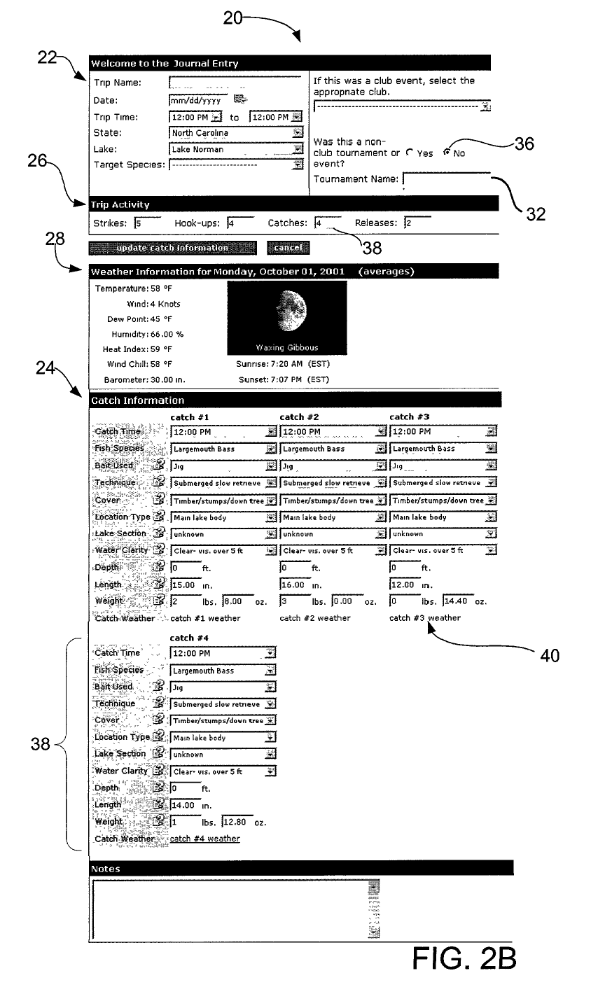

The GUI 18, which can comprise any of a number of known devices, is responsive to the processing element 16 for displaying the electronic game information. In this regard, reference is now made to FIGS. 2A and 2B, which illustrates one exemplar fishing information input display, or journal entry display 20, from the GUI. It should be understood, though, that the displays illustrated are for example purposes, and that the display can take many different forms and include information for many different types of game. Because, as stated before, since anglers preferably continue to take fishing trips and continue to gather fishing information, an angler would typically input fishing information into the processing element based upon the fishing information input display after one or more fishing trips. As shown, the journal entry display includes various fields for receiving the fishing information related to a selected fishing trip. The fields can additionally be broken into sections by information type, including trip information 22, catch information 24 (including trip activity 26). Average weather and water information can additionally be displayed in a weather information section 28 and a water information section (not shown), respectively, based upon the date of the fishing trip. The average weather and water information can be determined by the processing element in any one of a number of manners, such as those outlined above. The average weather and water information can be displayed at any time after receiving a date associated with the fishing information, such as by updating the journal entry display, as shown in FIG. 2B. As the fishing information can be broken down into sections, each section can be displayed individually, or in groups, or altogether, as shown. The fishing information can be received and displayed in any of a number of manners, including via a text field 32, a drop-down menu 34 and a button select 36.

As shown, the various fields within the catch information section 24 consist of catch groups 38, with each catch group including fields for receiving information regarding each fish caught during the given fishing trip. As apparent, the number of catch groups necessary for a given fishing trip will vary depending upon the number of fish caught during a given fishing trip. Therefore, the number of catch groups displayed by the GUI 18 preferably varies in response to the number of fish caught during the respective fishing trip. In this regard, the trip activity section includes a catches field 38, which can be used to receive the number of fish caught during the fishing trip and thereafter determine the number of catch groups displayed in the catch information section.

As previously stated, in addition to receiving the game information the processing element 16 can determine the weather during each catch based upon the estimated catch time and location of the catch. In this regard, the journal entry display 20 displayed by the GUI 18 can include a weather element 40, as shown in FIG. 2B. The weather element can comprise any of a number of different elements but, in the preferred embodiment, comprises a pointer such as a hypertext link (e.g., “catch weather”). Once an angler selects the weather element, the processing element 16 determines the weather along the lines described above. The GUI can then display the weather such as in the weather information section 28 of the fishing information input display or in a separate display (not shown). In an alternative embodiment, once the angler has input the date of the fishing trip and after the angler has input the time for each catch of the fishing trip, the processing element can automatically determine the weather and, thereafter, the GUI can display the weather for each respective catch, such as by updating the journal entry display with the weather information.

After the processing element 16 has received all of the game information, the processing element can save the game information into the electronic databases 12. Thereafter, the processing element can display the game information in any of a number of different manners, including displaying the game information by a selected hunting area, which could include game information for all hunters of a particular game who previously input respective game information associated with the respective hunting area. Also, the game information can be displayed by a selected hunter and a selected hunting trip, in a manner similar to the journal entry display 20. Additionally, based at least partially upon the hunting information, the processing element can determine and generate dynamic electronic information for display by the GUI 18 to improve hunters' future hunting experiences, including dynamic electronic information such as predictions and graphical summaries of hunters' hunting experiences by a selected hunting area. As such, in a typical application, the hunter would display the game information and/or the dynamic electronic information prior to taking a future hunting trip to thereby plan the optimum conditions upon which to take the hunting trip.

The processing element 16 can determine predictions for a number of different aspects of hunting, including such things as the probably of success, and the best methods, timing, equipment and location for catching game. In this regard, the processing element will preferably utilize neural network technology along with at least a portion of the fishing information stored by the electronic database. As known to those skilled in the art, neural network technology is technology modeled upon the human brain's interconnected system of neurons. Based upon this premise, the neural network technology allows processing element can imitate the brain's ability to sort out patterns and learn from trial and error, discerning and extracting the relationships that underlie the fishing information. The network learns when the previously received fishing information (with known results) is presented to processing element. Factors associated with the known results are then adjusted to bring the final predictive output closer to the known result.

In addition to determining predictions, the processing element 16 can generate dynamic electronic information consisting of summaries of hunting experiences of at least one hunter, preferably a plurality of hunters, based upon a selected hunting area and a defined period of time, which are then displayable by the GUI 18. Also, the dynamic electronic information can further be based upon a selected game species, in addition to the selected hunting area and defined period of time. The dynamic electronic information can include any of a number of different graphical summaries for the selected hunting area in the defined time period. For example, with respect to fishing information, the dynamic electronic information can include information such as number of fish caught, average catch per angler, average size of the fish caught, the largest fish caught, the high and low water temperatures, and the high and low barometric pressure readings. Also, the dynamic electronic information can include summaries for a selected fishing area such as, the average catch per hour, the average precipitation, and the chances of catching a particular species of fish in a future time period (such as by utilizing the neural network technology).

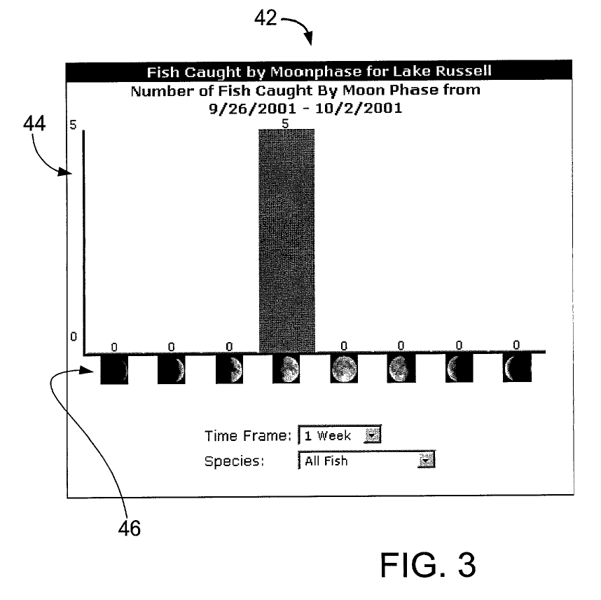

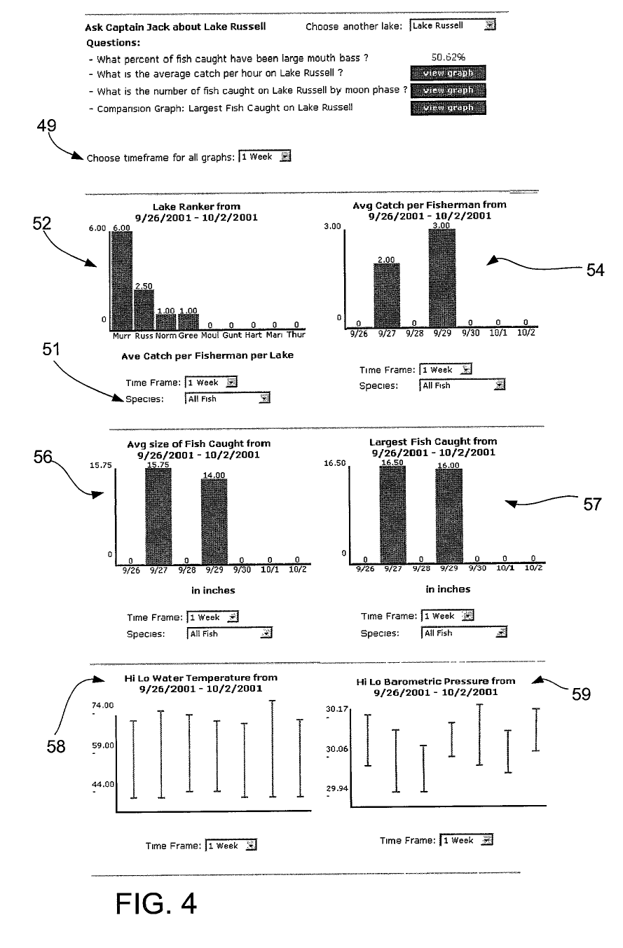

Referring now to FIGS. 3 and 4, which illustrate exemplar displays with respect to fishing information, the GUI 18 can display the dynamic electronic information in any one of a number of different manners. For example, as shown in FIG. 3, the display can consist of a bar graph 42 of the number of fish caught in the last predetermined time period (e.g., week) by moon phase, with the number of fish caught represented by the bars extending along the vertical axis 44, and the moon phase represented along the horizontal axis at 46 the point of origin of the bars. As shown, for example, five fish were caught during the defined week at the selected lake during one moon phase, with no other fish caught during the week.

Additionally, or alternatively, the GUI can display a number of different summaries for a given lake, as shown in FIG. 4. For example, the GUI can display various graphs for the selected lake with a defined time period selected from a time select element 49, such as by a drop-down menu associated with the graphs. Also, the GUI can display the summaries further based upon a fish species, by selecting a fish species from a species select element (not shown). Additionally, or alternatively, a plurality of defined time periods can be selected by a plurality of drop-down menus, with each time period associated with a respective graph. Similarly, the a plurality of fish species can be selected from a plurality of species select elements 51, such as a plurality of drop-down menus. As shown, for example, the GUI can display summaries by displaying graphs for a selected lake over a defined period of time, including the average catch per fisherman (i.e., angler) per lake 52, the average catch per fisherman 54, the average size of fish caught 56, and the largest fish caught 57, the high-low water temperature 58 and the high-low barometric pressure 59. The GUI can further display summaries by displaying graphs for dynamic electronic information such as average catch per hour, number of fish caught per moon phase (as described above), and comparison of largest fish caught on the selected lake during all time periods to the largest fish caught by a selected angler. Based on this information, anglers are provided with the information necessary to formulate an adequate determination of the likelihood of a fish striking at any given time. Thus, anglers can fish more wisely and statistically should have a better chance of catching fish.

The present invention therefore provides systems, methods and computer program products for accessing electronic game information that includes game information for a plurality of hunters to provide more comprehensive game information. In this regard, the present invention provides hunters with the information necessary to formulate an adequate determination of the likelihood of catching game at any given time. In addition, the present invention provides hunters with objective and consistent weather determinations, which further enhance the hunting information.

In various advantageous embodiments, portions of the system and method of the present invention include a computer program product. The computer program product includes a computer-readable storage medium, such as the non-volatile storage medium, and computer-readable program code portions, such as a series of computer instructions, embodied in the computer-readable storage medium. Typically, the computer program is stored and executed by a processing unit or a related memory device, such as the processing element 16 as depicted in FIG. 1.

In this regard, FIGS. 1-4 are block diagram, flowchart and control flow illustrations of methods, systems and program products according to the invention. It will be understood that each block or step of the block diagram, flowchart and control flow illustrations, and combinations of blocks in the block diagram, flowchart and control flow illustrations, can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for accessing electronic game information for a plurality of hunters comprising:
a processing element capable of receiving game information, wherein the game information is associated with at least one hunting area, and wherein at least a portion of the electronic game information is associated with at least one hunting trip having at least one time, wherein said processing element is capable of determining weather information for the at least one time during the at least one hunting trip;
at least one electronic database responsive to said processing element for storing electronic game information for the plurality of hunters based upon the game information input into said processing element, wherein said at least one electronic database is capable of storing the weather information determined by said processing element along with the electronic game information, and wherein said processing element is located remote from said at least one electronic database; and
an output element capable of outputting dynamic electronic information at least partially based upon the game information and the plurality of hunters, wherein said output element is further capable of outputting the weather information for the at least one time during the at least one hunting trip.

2. A system according to claim 1, wherein said output element comprises a graphical user interface (GUI), wherein said GUI is capable of displaying dynamic electronic information at least partially based upon the electronic game information and the plurality of hunters, and wherein said GUI is further capable of displaying the weather information for the at least one time during the at least one hunting trip.

3. A system according to claim 2, wherein said GUI is responsive to a selection of at least a portion of the electronic game information to thereby display dynamic electronic information over a predetermined time period.

4. A system according to claim 1 further comprising at least one electronic weather database capable of storing electronic weather information, wherein said processing element is capable of determining the weather information by communicating with said at least one electronic weather database.

5. A system according to claim 4, wherein said electronic weather information is stored in said at least one electronic weather database based upon a time and location, and wherein said processing element is capable of determining the weather information according to the times of the respective hunting trips and further according to at least one place of the respective hunting trips.

6. A system according to claim 1, wherein said processing element is capable of storing the electronic game information in the at least one electronic database based upon the plurality of hunters and based upon the at least one hunting area, and wherein said output element is capable of outputting the electronic game information based upon at least one of the plurality of hunters and the at least one hunting area.

7. A system according to claim 1, wherein said processing element communicates with said at least one electronic database across a wide area network (WAN).

8. A system according to claim 7, wherein the WAN comprises the Internet.

9. A method for accessing electronic game information for a plurality of hunters comprising:
inputting game information, wherein the game information is associated with at least one hunting area, and wherein at least a portion of the electronic game information is associated with at least one hunting trip;
determining weather information for at least one time during the at least one hunting trip;
storing electronic game information for the plurality of hunters based upon the game information input, wherein storing further comprises storing the weather information determined along with the electronic game information; and
outputting dynamic electronic information at least partially based upon the electronic game information and the plurality of hunters, wherein outputting further comprises outputting the weather information for the at least one time during the at least one hunting trip, wherein displaying further comprises displaying dynamic electronic information at least partially based upon the electronic game information and the plurality of hunters.

10. A method according to claim 9, wherein outputting the dynamic electronic information comprises displaying the dynamic electronic information.

11. A method according to claim 10, wherein displaying further comprises selecting at least a portion of the electronic game information before displaying the electronic game information and the weather information.

12. A method according to claim 9, wherein determining the weather information comprises communicating with at least one electronic weather database to thereby determine the weather information.

13. A method according to claim 12, wherein communicating with the at least one electronic weather database comprises communicating with the at least one electronic weather database according to the at least one time during the at least one hunting trip and further according to at least one place of the at least one hunting trip.

14. A method according to claim 8, wherein storing comprises storing the electronic game information based upon the plurality of hunters and based upon the at least one hunting area, and wherein displaying comprises displaying the electronic game information based upon at least one of the plurality of hunters and the at least one hunting area.

15. A method according to claim 9, wherein storing comprises storing the electronic game information by communicating with at least one electronic database across a wide area network (WAN).

16. A method according to claim 15, wherein storing comprises storing the electronic game information by communicating with the at least one electronic database across the Internet.

17. A computer program product for accessing electronic game information for a plurality of hunters, the computer program product comprising a computer-readable storage medium having computer-readable program code embodied in said medium, the computer-readable program code comprising:
a first executable portion for receiving game information, wherein the game information is associated with at least one hunting area, and wherein at least a portion of the electronic game information is associated with at least one hunting trip;
a second executable portion for determining at least one weather for at least one time during the at least one hunting trip;
a third executable portion for storing electronic game information for the plurality of hunters based upon the game information, wherein storing further comprises storing the weather determined along with the electronic game information; and
a fourth executable portion for outputting dynamic electronic information at least partially based upon the electronic game information and the plurality of hunters, wherein said fourth executable portion further outputs the weather information for the at least one time during the at least one hunting trip.

18. A computer program product according to claim 17, wherein said fourth executable portion outputs the dynamic electronic information and weather information by displaying the dynamic electronic information and weather information.

19. A computer program product according to claim 17, wherein said fourth executable portion further selects at least a portion of the electronic game information before outputting the electronic game information and the at least one weather.

20. A computer program product according to claim 17, wherein said second executable portion communicates with at least one electronic weather database to thereby determine the weather information.

21. A computer program product according to claim 20, wherein said second executable portion communicates with the at least one electronic weather database according to the at least one time during the at least one hunting trip and further according to at least one place of the at least one hunting trip.

22. A computer program product according to claim 17, wherein said third executable portion stores the electronic game information based upon the plurality of hunters and based upon the at least one hunting area, and wherein said fourth executable portion outputs the electronic game information based upon at least one of the plurality of hunters and the at least one hunting area.

23. A computer program product according to claim 17, wherein said third executable portion stores the electronic game information by communicating with at least one electronic database across a wide area network (WAN).

24. A computer program product according to claim 23, wherein said third executable portion stores the electronic game information by communicating with the at least one electronic database across the Internet.
